(19) United States
(12) Patent Application Publication
(10) Pub. No.: US 2024/0088920 A1
(43) Pub. Date: Mar. 14, 2024

(54) VIRTUAL RADIO INTERFACE

(71) Applicant: Simnovus Corporation, Cary, NC (US)

(72) Inventors: Sanjib Ranjan Pradhan, Bargarh (IN); Harshith Dhananjaya, Bangalore (IN)

(73) Assignee: Simnovus Corporation, Cary, NC (US)

(21) Appl. No.: 18/241,348

(22) Filed: Sep. 1, 2023

Related U.S. Application Data
(60) Provisional application No. 63/404,756, filed on Sep. 8, 2022.

(51) Int. Cl. H04B 1/00

(52) U.S. Cl. CPC H04B 1/0003

(57) ABSTRACT

The present invention provides a virtualized radio interface operable to share physical resources of multiple user equipment (UE) on a single software defined radio (SDR) device, as well as systems and methods for using the virtualized radio interface. The virtualized radio interface provides parallel use of the radio by different instances of the UE stack. Further, the virtualized radio interface is compatible with existing implementations of UE stacks used in commercial UEs as well as open source UEs to facilitate a multi-stack single radio implementation. Use cases include multi-UE simulators with a single UE stack and transforming a UE to a device operable to handle multiple connections using a single radio interface.

### CROSS REFERENCES TO RELATED APPLICATIONS

This application is related to one or more prior filed US patent applications. This application claims priority to and the benefit of U.S. Provisional Patent Application No. 63/404,756, filed Sep. 8, 2022, which is incorporated herein by reference in its entirety.

### BACKGROUND OF THE INVENTION

### 1. Field of the Invention

The present invention relates to radio interfaces, and more specifically to a virtualized radio interface operable to share physical resources of multiple user equipment (UE) on a single software defined radio (SDR) device.

### 2. Description of the Prior Art

It is generally known in the prior art to provide user equipment (UE) simulators that are used for validation of base stations. These UE simulators are typically able to run multiple UEs sharing the same physical layer.

Prior art patent documents include the following:

U.S. Pat. No. 10,797,733 for Distributed antenna systems by inventor Shattil, filed Jul. 3, 2019 and issued Oct. 6, 2020, is directed to a multi-user multiple antenna system in which a central processor is communicatively coupled to a plurality of geographically distributed access points via a network. The central processor selects two or more of the distributed access points to serve each of a plurality of user devices based on signal power of wireless links between each user device and the distributed access points. The central processor performs subspace processing on the signals transmitted and/or received across the plurality of distributed access points for producing a plurality of non-interfering spatial subchannels.

U.S. Publication No. 20200107327 for Beam management with multi-transmission reception point multi-panel operation by inventors Wang, et al., filed Jun. 15, 2018 and published Apr. 2, 2020, is directed to an apparatus configured to be employed within a base station. The apparatus comprises baseband circuitry which includes a radio frequency (RF) interface and one or more processors. The one or more processors are configured to generate one or more signals for transmission to a user equipment (UE) device, wherein the UE device has a plurality of antenna panels; receive a beam state report from the RF interface from the UE device; select beams for communication with one or more of the plurality of antenna panels based on the received beam state report.

U.S. Pat. No. 10,470,064 for Enhanced radio resource management reporting in cellular systems by inventors Davydov, et al., filed Dec. 23, 2015 and issued Nov. 5, 2019, is directed to User Equipment (UE) and base station (eNB) apparatus and methodology for radio resource management reporting. The UE receives reference signals from at least one antenna port of an eNB via a plurality of receive antennas of the UE. The UE performs received signal measurement of at least a portion of the reference signals for a plurality of eNB antenna port and UE receive antenna combinational groupings to produce enhanced received signal quality (eRSQ) measurements that represent spatial characteristics of the reference signaling as received by the UE. The UE may send a report to the eNB based on the eRSQ measurements, with the report being indicative of spatial multiplexing layer availability of the UE to be served by the eNB.

U.S. Pat. No. 11,088,744 for Methods, systems, and computer readable media for 5G digital beamforming testing by inventors Hammond, et al., filed Feb. 7, 2020 and issued Aug. 10, 2021, is directed to a method for 5G digital beamforming testing that includes receiving emulated UE spatial positions. The method includes computing phase vectors for the emulated UEs based on the emulated UE spatial positions and communicating the phase vectors to a DUT. The method includes receiving beam weight sets from the DUT and storing the beam weight sets. The method includes computing scores for the emulated UE spatial positions from the beam weight sets and the phase vectors, and receiving, from the DUT, spatial streams and identifiers of beam weight sets to be used to transmit the spatial streams to the emulated UEs. The method includes identifying, using scores corresponding to the beam weight sets to be used to transmit the spatial streams to the emulated UEs, associations between the spatial streams and the emulated UE spatial positions. The method includes processing data in the spatial streams using the emulated UEs.

U.S. Publication No. 20210368547 for Truncated identification indicators for early user equipment (UE) capability retrieval by inventors Kadiri, et al., filed May 20, 2021 and published Nov. 25, 2021, is directed to a base-station (BS) receiving a random access request from user equipment (a UE), followed by a connection request. The connection request contains UE identity information which may have one of multiple formats depending on whether the access request and/or the connection request indicate that the UE is operating as a bandwidth-limited (BL) UE, an enhanced coverage (CE) UE, or a UE that operates in neither the BL mode nor the CE mode. In the BL mode, the UE may transmit a truncated identifier that is sufficient for the BS to retrieve capability information for the UE prior to transmitting a resource grant to the UE. The BS may then configure the UE and BS to using a radio configuration optimized for the UE's capabilities and transmit the resource grant in accordance with the optimized configuration.

U.S. Publication No. 20170026876 for Tune away procedure based on TDD uplink/downlink configuration by inventors Yang, et al., filed Jul. 20, 2015 and published Jan. 26, 2017, is directed to a method and system for wireless communication in a time division duplex (TDD) system in a multi-SIM (subscriber identity module) multi-standby, single receiver UE (user equipment) that adjusts a tune away procedure based on a current time division duplexing (TDD) uplink/downlink configuration and/or number of active component carrier of carrier aggregation. The UE (user equipment) determines when to start a tune away from a first RAT (radio access technology) to a second RAT (radio access technology) based, at least in part, on a current TDD (time division duplexing) uplink/downlink configuration of the first RAT (radio access technology).

U.S. Pat. No. 9,474,105 for User equipment having a multiple subscriber identity module capability understood by one or more networks by inventors Awoniyi-Oteri, et al., filed Jan. 23, 2015 and issued Oct. 18, 2016, is directed to a user equipment (UE) that may determine a capability of the UE to support multiple subscriber identity modules (SIMs). The multiple SIMS may enable the UE to communicate with multiple network nodes. The UE may notify at least one network node of the multiple network nodes of the multiple SIM capability of the UE.

U.S. Pat. No. 11,240,825 for Bandwidth part selection for multi-subscriber user equipment by inventor Kumar, filed Sep. 14, 2020 and issued Feb. 1, 2022, is directed to wireless communication. In some aspects, a user equipment (UE) may determine a frequency overlap between a first transmission, with a first base station associated with a first subscription of the UE, on a first bandwidth part, and a second transmission, with a second base station associated with a second subscription of the UE, on a second bandwidth part. The UE may transmit, to the second base station, a request for a new bandwidth part for the second subscription, based at least in part on the frequency overlap satisfying a condition. Numerous other aspects are provided.

U.S. Pat. No. 11,101,871 for Beam selection for multi-subscriber identity module (MSIM) devices by inventors Karakkad Kesavan Namboodiri, et al., filed Feb. 10, 2020 and issued Aug. 24, 2021, is directed to a method of wireless communication that includes searching, at a user equipment (UE) having a first subscriber identity module (SIM) and a second SIM, transmit beams from a base station and receive beams from the UE to determine a subset of transmit beams. The method also includes storing indicators of the subset of transmit beams in a database accessible to the UE in response to the second SIM performing a particular operation that causes the first SIM to perform a tune away operation. The method further includes, after completion of the particular operation, performing measurement operations on the subset of transmit beams to select a particular transmit beam of the subset of transmit beams and a corresponding particular receive beam for attachment to the base station.

U.S. Pat. No. 11,005,623 for Demodulation reference signal configuration for shortened transmission time interval baseline pattern by inventors Hosseini, et al., filed Apr. 18, 2019 and issued May 11, 2021, is directed to methods, systems, and devices for wireless communications. One method may include identifying a baseline demodulation reference signal (DMRS) mapping pattern for mapping of DMRS data to resource elements (REs) within a shortened transmission time interval (sTTI) based on a number of layers for which a user equipment (UE) is configured. In some examples, the number of layers may be configured on a per-unit basis. The method may further include determining a shifted DMRS mapping pattern based on the baseline DMRS mapping pattern and a reference signal configuration associated with reference signals other than a DMRS, configuring REs within the sTTI according to the shifted DMRS mapping pattern, and transmitting the configured REs.

U.S. Publication No. 20210112398 for methods and systems for managing decoding of control channels on a multi-SIM UE by inventors Mishra, et al., filed Oct. 12, 2020 and published Apr. 15, 2021, is directed to Methods and systems for managing decoding of control channel on a multi-SIM UE. A method includes receiving, by the UE, the plurality of control channels from at least one Base Station (BS), the plurality of control channels corresponding to a plurality of Subscriber Identity Modules (SIMs), selecting, by the UE, a respective decoder for each of the plurality of SIMS, and decoding, by the UE, each respective control channel among the plurality of control channels using the respective decoder for a respective SIM among the plurality of SIMS, the respective SIM corresponding to the respective control channel.

### SUMMARY OF THE INVENTION

The present invention relates to radio interfaces, and more specifically to a virtualized radio interface operable to share physical resources of multiple user equipment (UE) on a single software defined radio (SDR) device.

It is an object of this invention to provide a virtualized radio interface compatible with a plurality of wireless technologies including, but not limited to, Fourth Generation Long Term Evolution (4G-LTE), Fifth Generation New Radio (5G-NR), WI-FI, and BLUETOOTH (e.g., BLUETOOTH Low Energy (BLE)). The present invention is compatible with UE platforms required to run multiple UE stacks on the same host without requiring changes to the implementation of the access point (AP).

In one embodiment, the present invention includes a system including a virtualized radio interface as described herein.

In another embodiment, the present invention includes a method of using a virtualized radio interface as described herein.

In yet another embodiment, the present invention includes a virtualized radio interface as described herein.

These and other aspects of the present invention will become apparent to those skilled in the art after a reading of the following description of the preferred embodiment when considered with the drawings, as they support the claimed invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates multiplexing and demultiplexing of a shared channel.

FIG. 2 illustrates an example of Frequency Division Multiple Access (FDMA).

FIG. 3 illustrates an example of Orthogonal Frequency Division Multiple Access (OFDM) sub-carriers.

FIG. 4 illustrates an example of OFDM channels divided over the given bandwidth.

FIG. 5 illustrates bandwidth parts (BWP) for 5G.

FIG. 6 illustrates an example of a resource grid for LTE/5G.

FIG. 7 illustrates a radio system design with a single user equipment (UE) protocol stack.

FIG. 8 illustrates a system with multiple UEs with many software defined radio (SDR) devices.

FIG. 9 illustrates a system with multiple UEs having a common physical (PHY) and single SDR device.

FIG. 10 illustrates SDR operations flow.

FIG. 11A illustrates a baseband signal at zeroth frequency.

FIG. 11B illustrates the baseband signal from FIG. 11A after conversion to the radio frequency (RF) domain.

FIG. 12 illustrates a multi-UE system design approach using a virtual SDR driver.

FIG. 13 illustrates one embodiment of the present invention including virtual SDR and hardware SDR configurations.

FIG. 14 illustrates a block diagram of one embodiment of the present invention.

FIG. 15A illustrates an example of quadrature phase shift keying (QPSK) in-phase bits for a first UE (UE-1), Symbol 1.

FIG. 15B illustrates an example of QPSK quadrature bits for UE-1, Symbol 1.

FIG. 16 illustrates an upsampled baseband signal of UE-1.

FIG. 17A illustrates an example of quadrature phase shift keying (QPSK) in-phase bits for a second UE (UE-2), Symbol 1.

FIG. 17B illustrates an example of QPSK quadrature bits for UE-2, Symbol 1.

FIG. 18A illustrates an example of QPSK in-phase bits for UE-2, Symbol 1.

FIG. 18B illustrates an example of QPSK quadrature bits for UE-2, Symbol 2.

FIG. 19 illustrates an upsampled baseband signal of UE-2.

FIG. 20 illustrates a multiplexed resultant signal sent to hardware SDR.

FIG. 21 illustrates a comparison plot between the original generated signal at the transmitter for UE-1 and the extracted signal at the receiver for UE-1.

FIG. 22 illustrates a comparison plot between the original generated signal at the transmitter for UE-2 and the extracted signal at the receiver for UE-2.

FIG. 23 illustrates time domain frequency shifting to extract the UE-2 signal.

FIG. 24A illustrates the QPSK in-phase bits for UE-1, Symbol 1.

FIG. 24B illustrates the QPSK quadrature bits for UE-1, Symbol 1.

FIG. 25A illustrates the QPSK in-phase bits for UE-2, Symbol 1.

FIG. 25B illustrates the QPSK quadrature bits for UE-2, Symbol 1.

FIG. 26A illustrates the QPSK in-phase bits for UE-2, Symbol 2.

FIG. 26B illustrates the QPSK quadrature bits for UE-2, Symbol 2.

FIG. 27 illustrates another embodiment of the present invention including virtual SDR and hardware SDR configurations.

FIG. 28 illustrates an example of performance mode.

FIG. 29 illustrates one example of performance mode with a hardware device with a practical bandwidth requirement meeting a total bandwidth requirement.

FIG. 30 illustrates another example of performance mode with a total bandwidth requirement exceeding the practical bandwidth requirement of the hardware device.

FIG. 31 is a schematic diagram of a system of the present invention.

### DETAILED DESCRIPTION

The present invention is generally directed to radio interfaces, and more specifically to a virtualized radio interface operable to share physical resources of multiple user equipment (UE) on a single software defined radio (SDR) device.

In one embodiment, the present invention includes a system including a virtualized radio interface as described herein.

In another embodiment, the present invention includes a method of using a virtualized radio interface as described herein.

In yet another embodiment, the present invention includes a virtualized radio interface as described herein.

Currently, a user equipment (UE) requires a dedicated pair of transmitter (Tx) and receiver (Rx) radio units. There are use cases that require multiple UE instances on the same system. Examples of such use cases include, but are not limited to, automation scenarios and laboratory validation. Having multiple Tx and Rx radio units makes the system bulky, expensive, and power consuming.

While there are UE simulators used for validation of base stations that are operable to run multiple UEs sharing the same radio Tx and Rx units, typically all the UEs share the same physical layer. Thus, the UEs are not independent of each other, and are not able to work with other commercial and open-source UE stacks.

The present invention solves the limitations of the prior art by providing a radio driver that facilitates parallel use of the radio by different instances of the UE stack. Further, the present invention is compatible with existing implementations of UE stacks used in commercial UEs as well as open source UEs to facilitate a multi-stack single radio implementation. Advantageously, the present invention is compatible with a plurality of wireless protocol technologies including, but not limited to, Fourth Generation Long Term Evolution (4G-LTE), Fifth Generation New Radio (5G-NR), WI-FI, and BLUETOOTH (e.g., BLUETOOTH Low Energy (BLE)). Further, the present invention advantageously is compatible with UE platforms required to run multiple UE stacks on the same host without requiring changes to the implementation of the access point (AP). The present invention also provides a solution to evaluate access points in terms of their capacity and handling of multiple uses running multiple UE stacks. Additionally, in LTE/5G-NR, the present invention is operable to evaluate a single UE attached to multiple operators, where each operator requires a different radio channel (e.g., SDR).

Referring now to the drawings in general, the illustrations are for the purpose of describing one or more preferred embodiments of the invention and are not intended to limit the invention thereto.

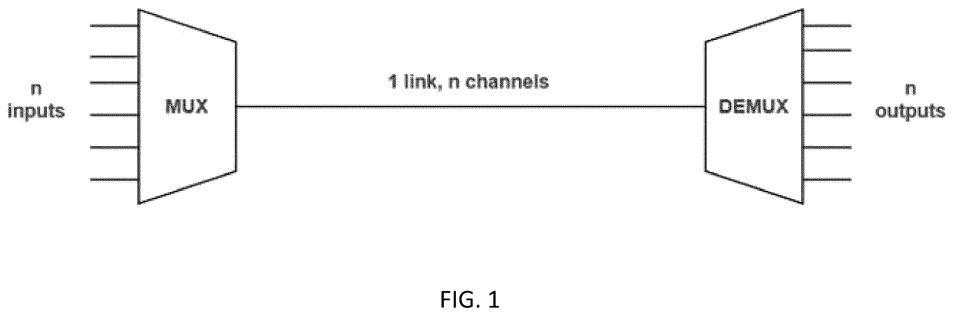

FIG. 1 illustrates wireless channel multiplexing and demultiplexing of a shared channel. The multiplexer device (MUX) combines n input signals to produce a signal suitable to be transmitted over a single channel and the demultiplexer device (DEMUX) at the receiving end separates the combined signal into n output signals.

Similarly, when n signals corresponding to n independent users are transmitted over a shared medium, this technique is called Multiple Access. Among various types of multiple access (or multiplexing) techniques, wireless network protocols like Long Term Evolution (LTE), fifth generation (5G) mobile networks, WI-FI, and BLUETOOTH low energy (BLE) utilize multiple access techniques including, but not limited to, Frequency Division Multiple Access (FDMA), Orthogonal Frequency Multiple Access (OFDMA), and/or Time Division Multiple Access (TDMA).

In telecommunications, multiple signals communicating simultaneously are operable to transmit data at the same time when independent signals are separated in frequencies, which is known as Frequency Division Multiplexing (FDM). The total bandwidth available in a communication medium is divided into a series of non-overlapping frequency bands and each band is used to carry a separate signal. Multiple independent signals of different radio frequencies are operable to share the same transmission medium.

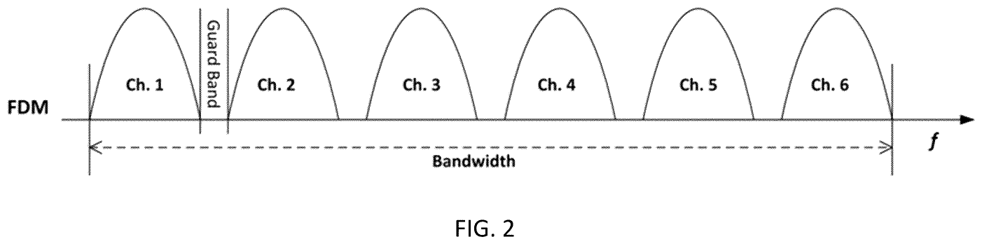

FIG. 2 illustrates an example of Frequency Division Multiple Access (FDMA). The bandwidth is divided into different channels and each channel is operable to be used for transmission independent of the other signals. Similarly, FDMA is used when different users with independent signals are assigned different frequency channels. Radio frequency (RF) signals from independent users separated in frequency channels are operable to transmit at the same time without any interference. As shown in FIG. 2, FMDA requires a guard band, resulting in low spectral efficiency.

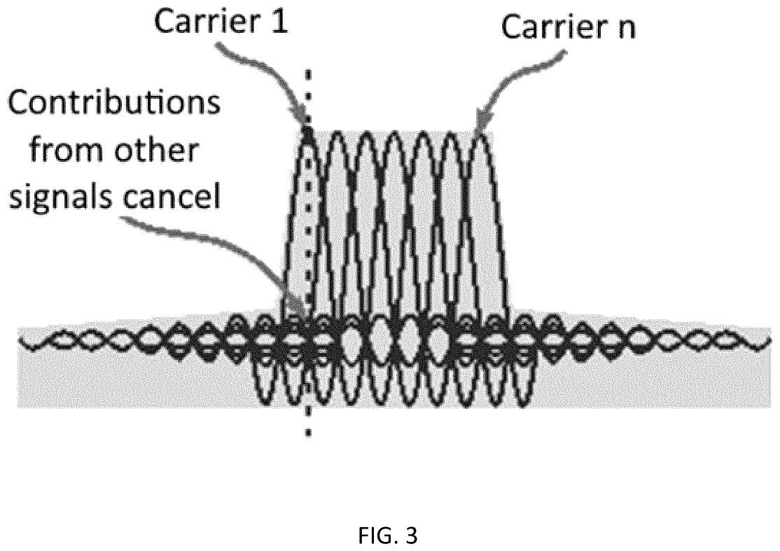

Orthogonal Frequency Division Multiplexing (OFDM) uses the same principle as frequency division multiplexing (FDM), but the available bandwidth is divided into a set of sub-carriers (or frequency bands) that are closely spaced to each other as shown in FIG. 3. Multiple user signals transmitted at the same time are operable to be assigned individual sub-carriers for transmission.

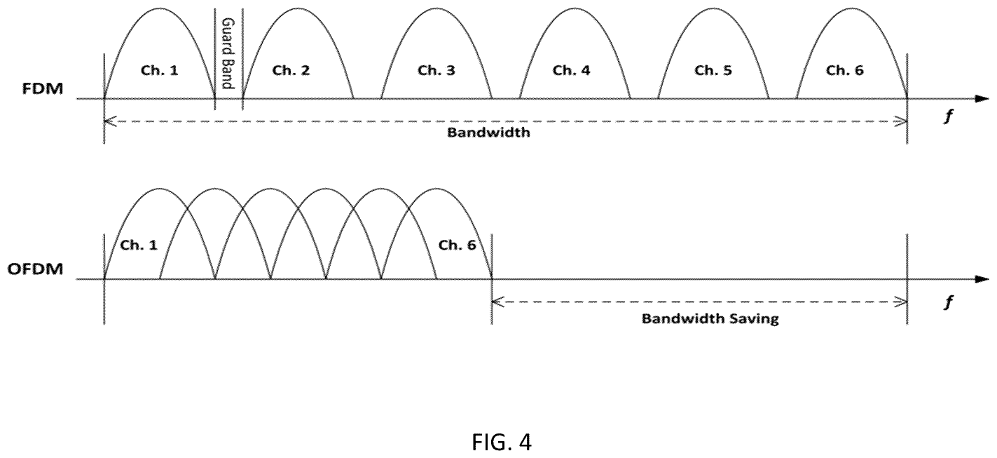

FIG. 4 illustrates an example with total bandwidth divided into closely spaced sub-carriers where each sub-carrier acts as a channel for Orthogonal Frequency Division Multiplexing Access (OFDMA) transmission compared to FDM. The principle of OFDM is adapted to OFDMA, i.e., multiple access technique for independent users. In OFDMA, the whole channel is operable to allocated to a single user at a time or is operable to be partitioned into a plurality of channels to serve multiple users simultaneously. As shown in FIG. 4, using OFDM provides a significant bandwidth saving because of channel overlap and elimination of the guard band used in FDM. Thus, OFDM provides a high spectral efficiency relative to FDM.

5G provides multiple access to independent users using FDMA, and a part of the resource grid (e.g., total gNodeB (gNB) bandwidth) is allocated to each user equipment (UE) by dividing the total grid into frequency channels called bandwidth parts (BWP).

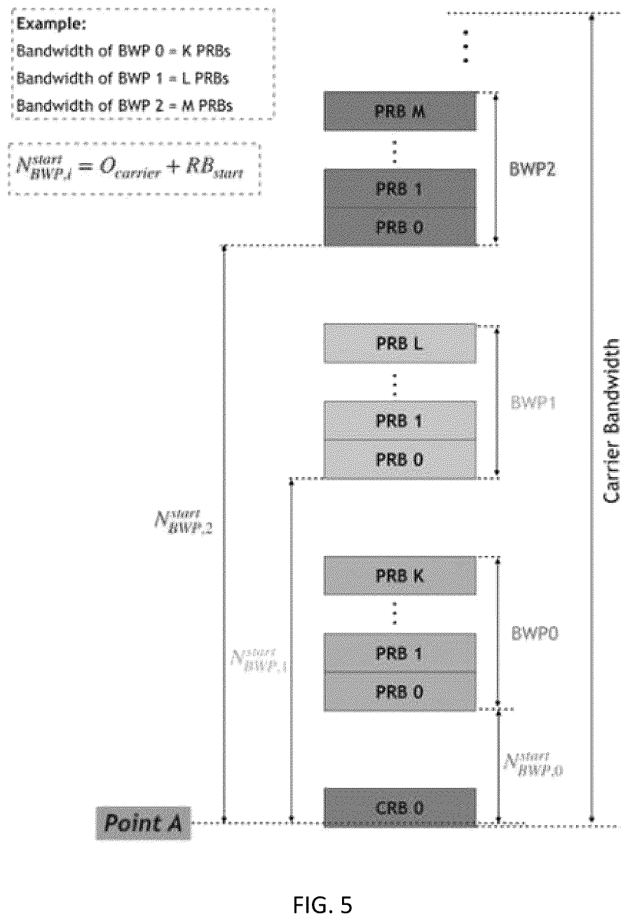

FIG. 5 illustrates three bandwidth parts (BWP0, BWP1, and BWP2) allocated to individual UEs. Each UE is operable to transmit and/or receive signals through its allocated bandwidth part.

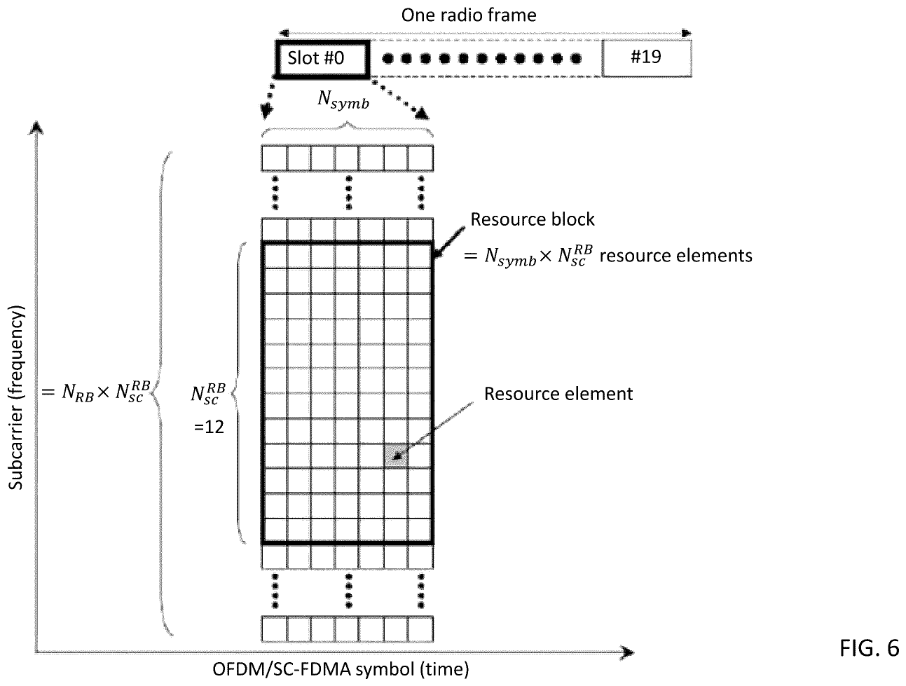

LTE achieves multiple access using only the OFDMA technique. The total bandwidth is divided into sub-carriers and a continuous band of sub-carriers are assigned to individual users (UEs). The resource grid looks the same for both 5G and LTE as seen in FIG. 6, where each square block is a sub-carrier that is operable to carry an individual signal and/or data stream.

Generally, the protocol stack implementation of UE radio for any of the wireless technologies (e.g., 4G/5G, WI-FI, BLE) include common media layers compliant to the Open System Interconnection (OSI) model. These common media layers include Layer 1 (the physical (PHY) layer), Layer 2 (the data link layer (DLL)), and Layer 3 (network layer). The physical layer includes basic networking hardware transmission technologies (e.g., electrical, mechanical) operable to transmitting bits. The physical layer provides bit synchronization, bit rate control, physical topologies, and/or transmission mode. The data link layer is divided into two sublayers: logical link control (LLC) and media access control (MAC). The data link layer is operable to provide framing, physical addressing, error control, flow control, and/or access control. The network layer provides packet forwarding via routing and logical addressing.

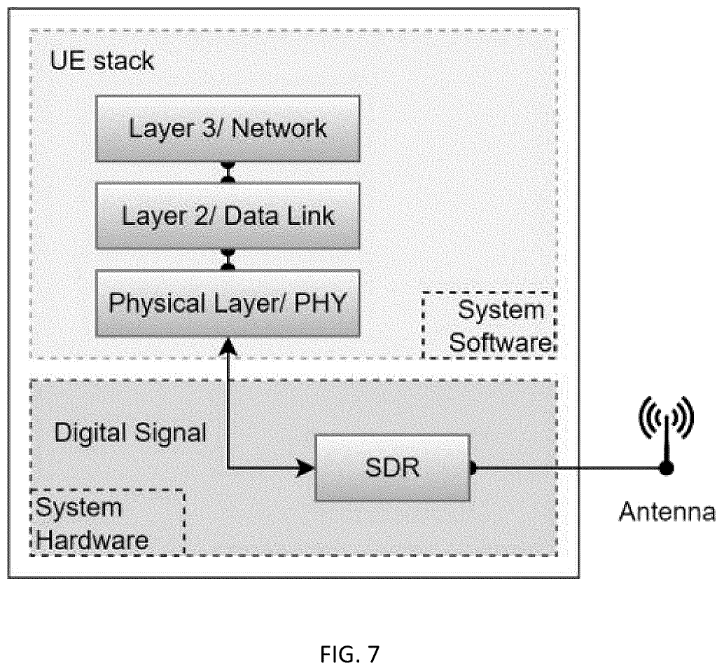

The advancements in the field of digital signal processing (DSP) and software defined radio (SDR) devices enable software implementation of the stack, which means that the entire protocol stack is operable to be designed purely over software and the generated digital data streams are sent into SDR hardware, which in turn converts digital signals into analog signals for transmission over the communication medium as seen in FIG. 7.

In applications where multiple UE protocol stacks are running on a single platform, the hardware requirements to fulfill the increased number of stacks are operable to be compensated by introducing additional SDR devices dedicated to each UE stack. Signals transmitted from all the UEs are not able to connect to a single SDR at the same time. Thus, single SDR sharing is not possible when all the UE instances are running independently and in situations where data streams from multiple UEs are requested to be transmitted at the same time.

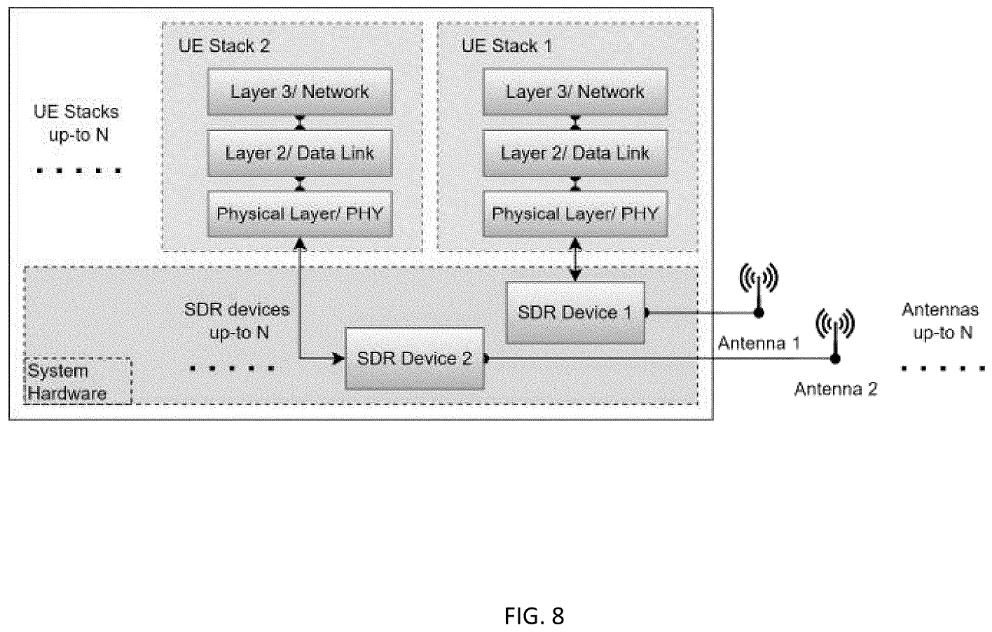

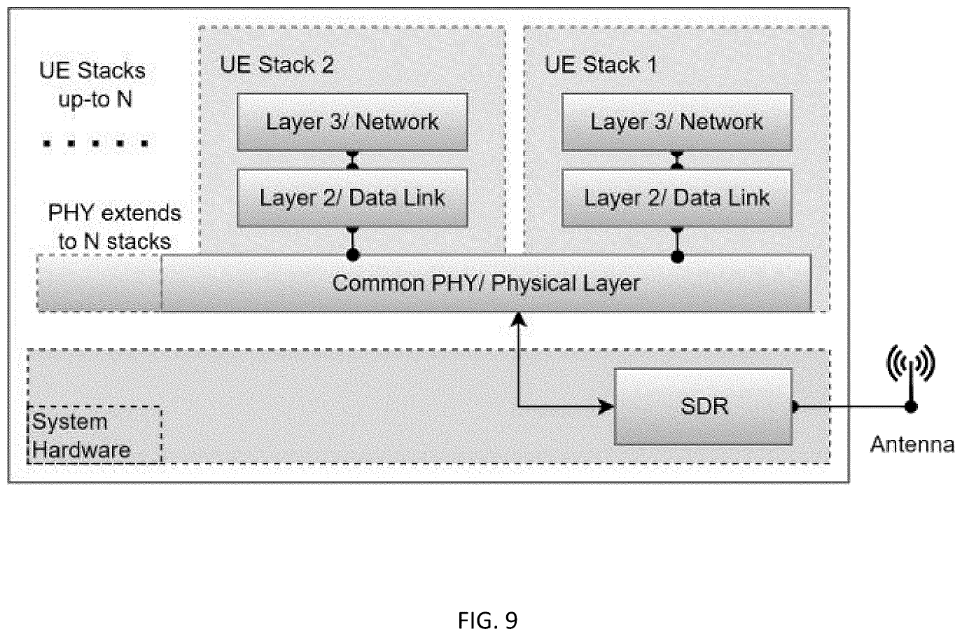

FIG. 8 illustrates a multi-UE system design approach with many SDR devices. The solution shown in FIG. 8 might solve the application problem, but the increase in hardware count increases the overall cost and power consumption of the system, which makes the design inefficient. Therefore, the next solution is to make the physical layer or PHY protocol of every UE common to all of the stacks as shown in FIG. 9. This is the basic principle of multi-UE simulation, where the digital signal generation corresponding to each of the UE stacks are combined within this common PHY layer and sent to hardware, such that a single SDR hardware is symbolically shared among all the UE stack instances.

The common PHY approach, shown in FIG. 9, is popularly used across communication applications including, but not limited to, multi-UE protocol stack simulators and lab automated testing equipment, but this design includes several limitations. For example, the UE stack at the physical layer must be redesigned to accommodate the common PHY system approach, which requires additional effort. Further, readily available UE stacks (e.g., commercial UEs, open-source UE stacks) are unable to be used for this purpose.

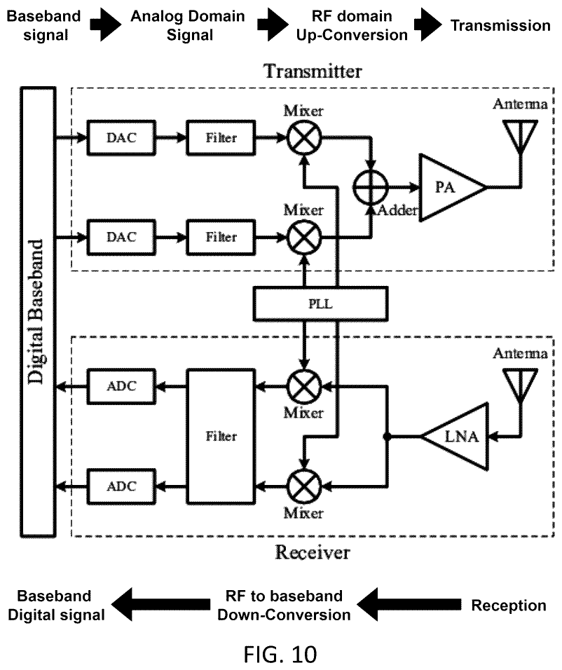

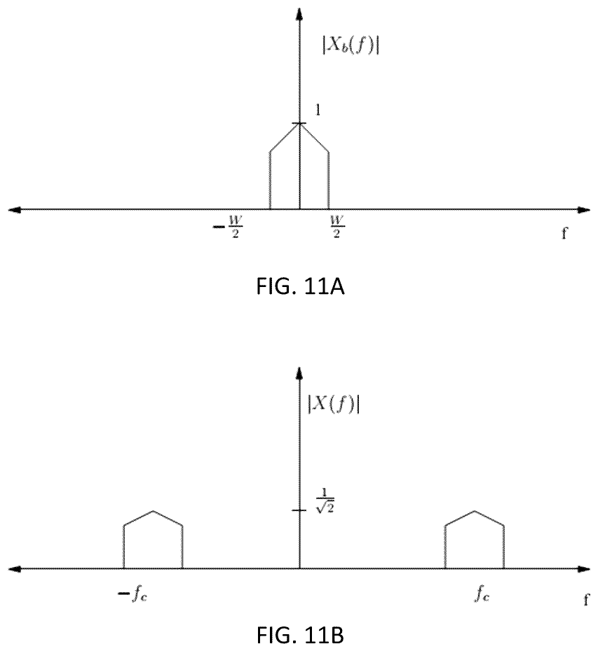

FIG. 10 illustrates SDR operations flow. There are two basic steps followed by an SDR device to achieve data transmission or reception: domain conversion and radio frequency up-conversion/down-conversion. Domain conversion includes digital to analog conversion using a digital-to-analog converter (DAC) for signal transmission and an analog-to-digital converter (ADC) for received signal. Input signals are called baseband signals, which means that frequencies located over the bandwidth are centered at zeroth frequency. The up-conversion process generates the RF signal for transmission, as illustrated in FIGS. 11A-B. The baseband signal shown in FIG. 11A, when up-converted to the center frequency ‘fc’, gets shifted into an RF domain signal as shown in FIG. 11B. Similarly, the down-conversion is the reverse process of up-conversion used for receiving signals from the RF domain and shifted to be processed at baseband.

Advantageously, the present invention includes system architecture and a virtualized software defined radio interface driver (vSDR driver) that solves the limitations of the prior art mentioned above.

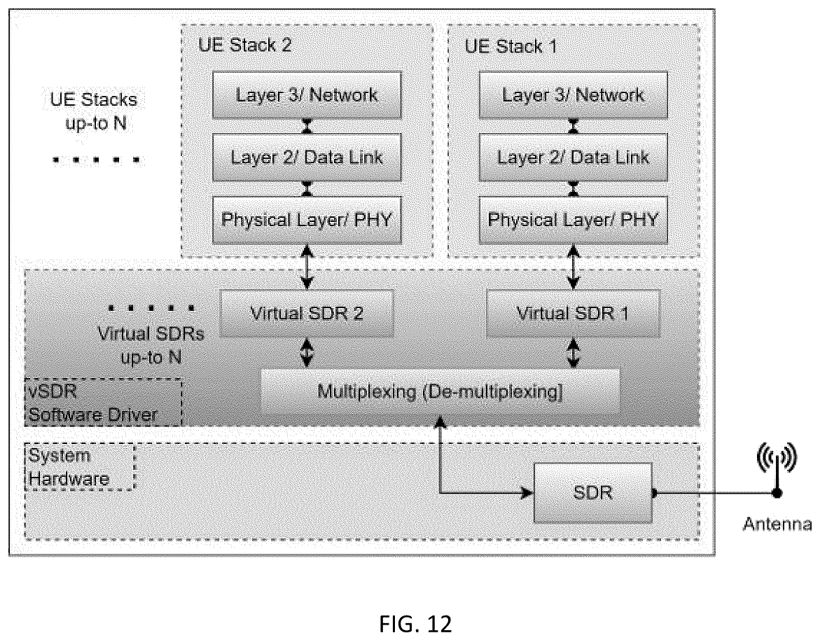

FIG. 12 illustrates a virtualized radio interface of the present invention that facilitates all UE instances on the system to access and/or share a single SDR hardware. Advantageously, the UE stack does not have to undergo any modification as required in the prior art. As shown in FIG. 12, each UE stack instance connects to a virtual port for sending and/or receiving digital data streams. The major function of the vSDR driver is to combine the signal in the up-link direction for all UE instances and stream the conjugated signal (in baseband) to the SDR hardware (i.e., multiplexing). In the down-link direction, the SDR receives the conjugated signal from the Access Point (AP), which is separated for each UE and provides the baseband signal as input to the corresponding UE.

The vSDR driver provides a virtual radio interface port to each UE, which supports two major services similar to the single UE and SDR hardware interaction scenarios. First, the vSDR is operable to configure a radio channel as required by each UE instance. Further, the vSDR is operable to provide real-time (or near-real-time) streaming of digital data in the up-link direction and/or the down-link direction. The vSDR preferably provides real-time streaming of digital data in the up-link direction and/or the down-link direction.

The UE is operable to configure the radio channel according to physical requirements of the UE while transmitting data in the up-link (UL) or receiving data through the down-link (DL). Each SDR of the vSDR is operable to be configured in real time (or near-real time) to match physical resources according to RF characteristics including, but not limited to, channel bandwidth (BW), sampling rate (fs), and/or channel center frequency (fc). Transmission bandwidth of the SDR hardware is the total bandwidth configured for the resource grid at the access point, whereas the UE configured bandwidth allocated is less than or equal to the total bandwidth of the access point. The sampling rate depends on the bandwidth of each UE, which is less than or equal to the sampling rate of the total bandwidth of the access point. The center frequency configured at each UE corresponds to the FDMA channel frequency allocated to the UE. Thus, the center frequency configured is used to shift the UE signal over the total bandwidth of the underlying SDR. Accordingly, the vSDR driver is operable to provide the digital data stream based on the configurations required by each UE, but the underlying SDR hardware is configured according to the RF signal characteristics required at the Access Point (AP).

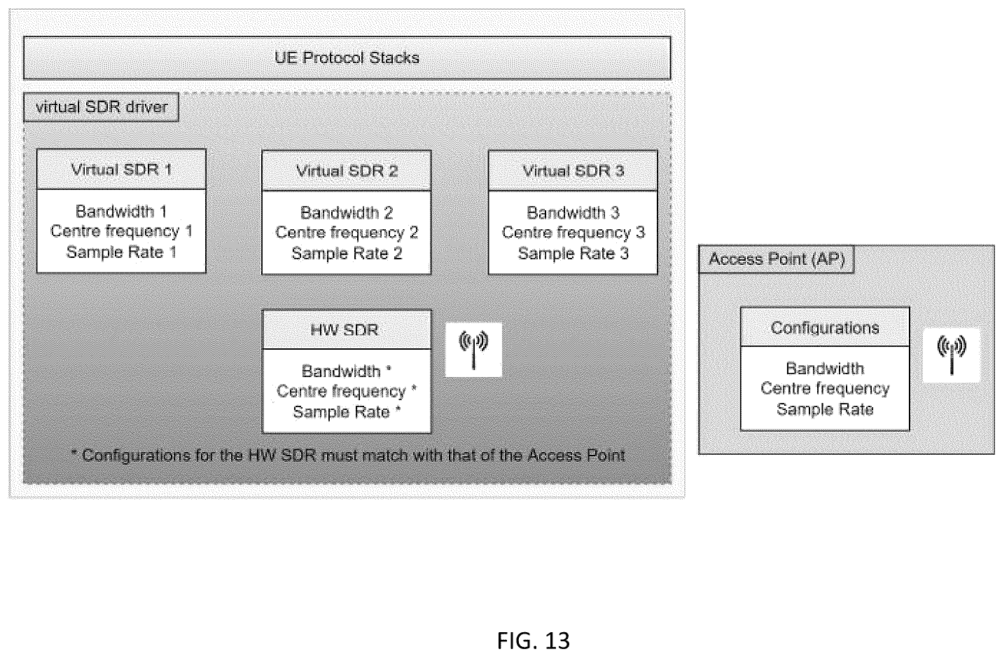

FIG. 13 illustrates a configuration profile for virtual SDRs and the hardware SDRs. In the embodiment shown in FIG. 13, the hardware SDR configuration is a clone of the access point, which allows for the total resources for all UE stacks to be allocated on demand.

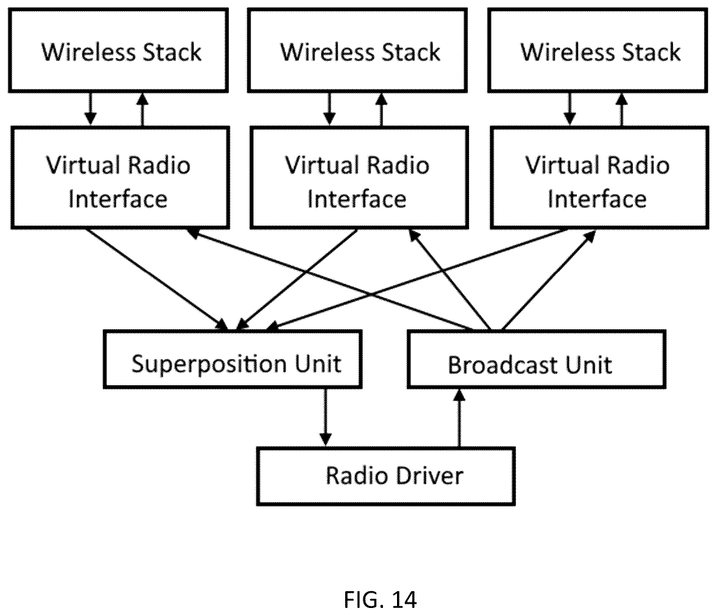

FIG. 14 illustrates a block diagram of one embodiment of the present invention. Each UE includes a wireless stack that is in communication with a virtual radio interface. Each virtual radio interface is in communication with a superposition unit and a broadcast unit. The superposition unit is operable to communicate with the radio driver. The radio driver is operable to communicate with the broadcast unit. In one embodiment, the superposition unit is operable to perform multiplexing. In one embodiment, the broadcast unit is operable to perform demultiplexing. Alternatively, the radio driver performs multiplexing and/or demultiplexing.

Data Streaming in Up-Link

The UE transmits data and the access point receives data over the RF channel during up-link. All UEs are operable to stream digital signals constructed in the baseband and the hardware SDR is responsible for up-conversion to RF. Thus, the multiplexing procedure is applied in the baseband to combine signals in the digital domain. The multiplexing procedure depends on the baseband signal characteristics configured at the vSDR and the hardware SDR. In one embodiment, the multiplexing procedure includes three operations: (1) up-sampling, (2) time domain frequency shifting, and/or (3) baseband signal multiplexing. In a preferred embodiment, the multiplexing procedure includes (1) up-sampling, (2) time domain frequency shifting, and (3) baseband signal multiplexing.

When the bandwidth and sampling rate configured at the corresponding vSDR and the SDR hardware is not the same, then up-sampling or interpolation is performed to the incoming digital stream to increase the sampling rate of the incoming stream. In one embodiment, the interpolation factor is calculated using the following equation:

$$Interpolation factor = \frac{sampling rate at hardware SDR}{sampling rate at virtual SDR}$$

Interpolation ensures the transmission stream to the SDR hardware is equal from every single virtual radio interface.

When the center frequency configured at a vSDR and the SDR hardware is not the same, then frequency shifting is performed to shift the UE signal bandwidth to the corresponding FDMA channel bandwidth. Frequency shifting is operable to be achieved with the digital streamed signal that is in the time domain by multiplying the time domain digital signal with a reference signal generated at the frequency given by the difference between the two configured frequencies (i.e., at vSDR and hardware SDR). In one embodiment, the reference frequency is calculated using the following equation:

reference frequency=center frequency at vSDR−center frequency at hardware SDR

This ensures that each UE signal does not interfere with any other signal in the frequency domain when transmitting to the SDR.

After the sampling rates from each of the virtual SDR interface ports are matched, then all digital streams are added together to form a single stream. The single stream is transmitted to the hardware SDR. In one embodiment, the hardware SDR stream is combined as follows:

Hardware SDR stream=[vSDR−1stream]+[vSDR−2stream]+ . . . +[vSDR−N stream]

This ensures that all signals from the UE stacks trying to transmit at a given time instance are combined and/or added and then transmitted into the communication medium.

Data Streaming in Down-Link

Down-link is the process where the access point (AP) transmits data and the UE receives data over the RF channel. Additionally, the access points are operable to transmit signals with a plurality (e.g., many, all) of the UE present along the total bandwidth based on the FDMA principle.

The combined signal received from the access point is separated and distributed into each UE. The hardware SDR converts the RF signal into a baseband signal through down-conversion. The de-multiplexing procedure is applied in the baseband domain to separate the signals from the digital streams. The de-multiplexing procedure depends on the baseband signal characteristics configured at the virtual SDR port and the hardware SDR. In one embodiment, the de-multiplexing procedure includes (1) time domain frequency shifting, (2) digital filtering, and/or (3) down-sampling. In a preferred embodiment, the de-multiplexing procedure includes (1) time domain frequency shifting, (2) digital filtering, and (3) down-sampling.

When the center frequency configured at a vSDR is not the same as the SDR hardware, frequency shifting is performed to shift the selected UE signal bandwidth corresponding to FDMA channel bandwidth to be positioned at the zeroth frequency. In one embodiment, frequency shifting is achieved by multiplying the incoming signal from the hardware SDR with a reference signal having a reference frequency. In one embodiment, the reference frequency is calculated as shown below:

Reference frequency=center frequency at hardware SDR−center frequency at vSDR

This ensures that the required band of signal located at a frequency channel in-between along the total bandwidth on the resource grid is shifted to the zeroth frequency to construct back the baseband signal.

When the combined signal includes bandwidth components from many UE streams, the shifted signal includes all of these bandwidth components. In one embodiment, the required bandwidth is filtered out by limiting the highest frequency corresponding to the bandwidth of the required UE to which the signal stream is distributed. In a preferred embodiment, a low pass filter is used. In one embodiment, the low pass filter includes a cutoff frequency. In one embodiment, the cutoff frequency is calculated using the equation below:

$$cutoff frequency = \frac{UE bandwidth}{2}$$

When the bandwidth and sampling rate configured at the vSDR and the SDR hardware are not the same, down-sampling or decimation is performed to the filtered digital stream to reduce the sampling rate before sending to the UE. In one embodiment, the system uses a decimation factor to provide a factor by which the sampling rate is reduced. In one embodiment, the decimation factor is calculated as follows:

$$decimation factor = \frac{sampling rate at vSDR}{sampling rate at hardware SDR}$$

This ensures that the high sampling from the incoming stream in the down-link is matched according to the required sampling rate provided to the UE.

FDMA Up-Link Transmission Example

5G New Radio (NR) is an example of a protocol where the total bandwidth is divided into frequency bands called bandwidth parts (BWP). This is basic principle behind frequency division multiple access (FDMA). In this example, two UEs transmitting signals are combined/multiplexed according to the resource grid configurations at gNB. OCTAVE software was used in both the up-link and down-link examples. The gNB is operating with a total bandwidth of 20 MHz at a sampling rate of 30.72 M samples per second with normal numerology 15 kHz and is supporting two user devices, UE-1 and UE-2. UE-1 is configured with a bandwidth of 5 MHz, an OFDM subcarrier spacing of 15 kHz, and a sampling rate of 7.68 M samples per second. UE-2 is configured with a bandwidth of 10 MHz, an OFDM subcarrier spacing of 30 kHz, and a sampling rate of 15.36 M samples per second. For this configuration, UE-1 Symbol 1 sequence length is computed to be 552 samples, which is upscaled to interpolation factor 4 to match the sampling rate of the hardware SDR. UE-2 Symbol 1 sequence length is computed to be 556 samples and UE-2 Symbol 2 sequence length is computed to be 548 samples, which are together upscaled to interpolation factor 2 to match the sampling rate at the hardware SDR. This upscaled signal results in a total sample count of 2208 samples which is inputted as one resultant symbol to the hardware SDR.

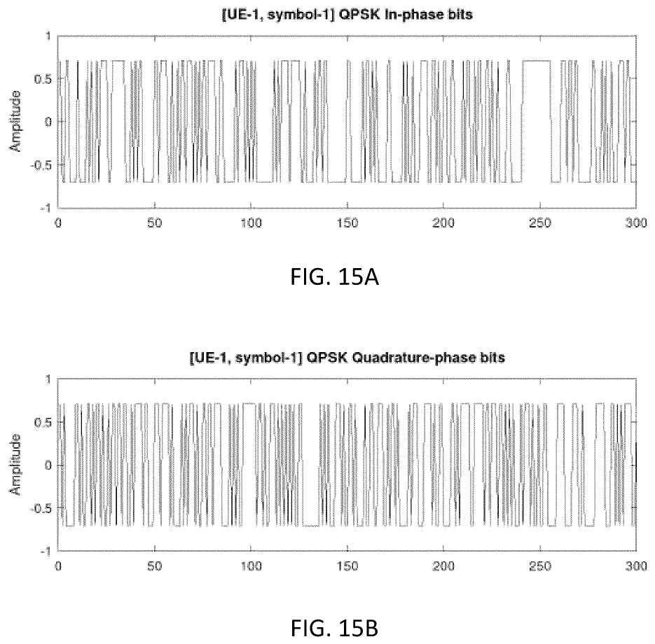

A QPSK signal is generated in the baseband for UE-1, Symbol 1. FIG. 15A illustrates an in-phase (I) plot for the generated QPSK signal for UE-1, Symbol 1. FIG. 15B illustrates a quadrature (Q) plot for the generated QPSK signal for UE-1, Symbol 1.

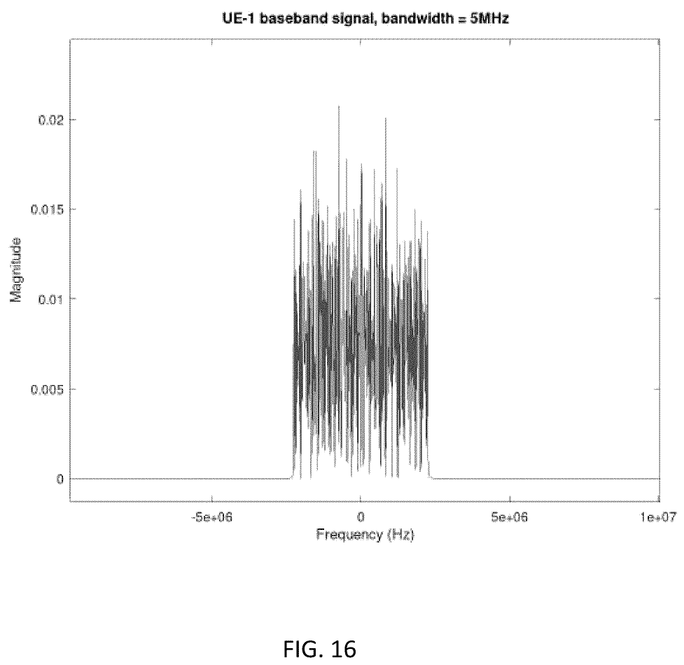

FIG. 16 illustrates an up sampled baseband signal of UE-1.

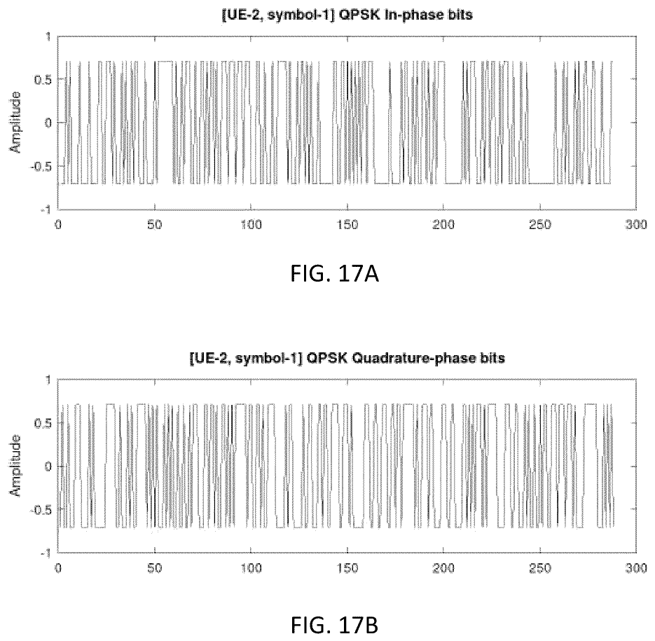

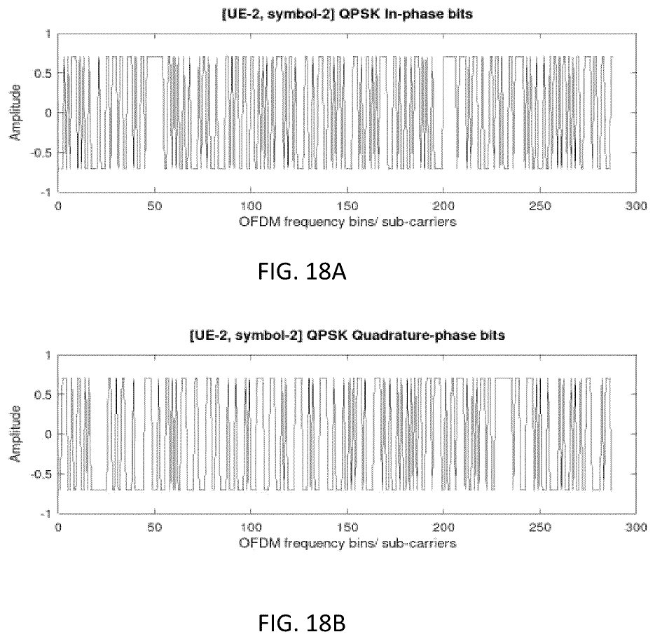

A QPSK signal is generated in the baseband for UE-2, Symbol 1 and UE-2, Symbol 2. FIG. 17A illustrates an in-phase (I) plot for the generated QPSK signal for UE-2, Symbol 1. FIG. 17B illustrates a quadrature (Q) plot for the generated QPSK signal for UE-2, Symbol 1. FIG. 18A illustrates an in-phase (I) plot for the generated QPSK signal for UE-2, Symbol 2. FIG. 18B illustrates a quadrature (Q) plot for the generated QPSK signal for UE-2, Symbol 2.

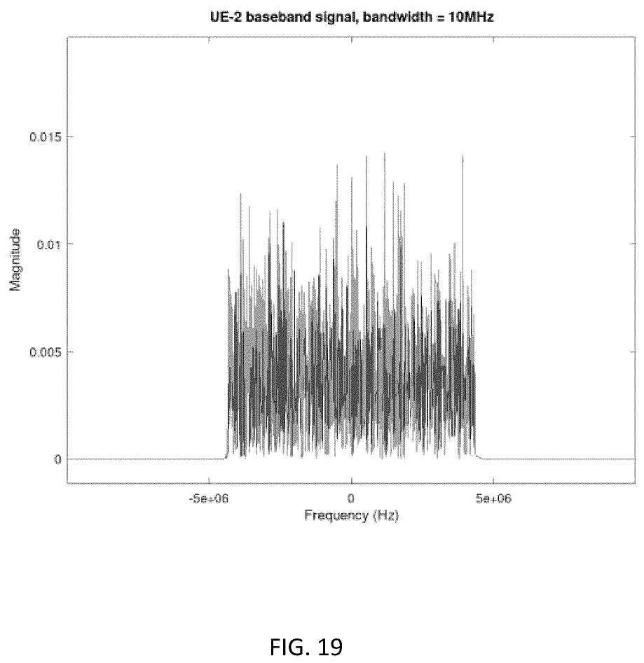

FIG. 19 illustrates an up sampled baseband signal of UE-2.

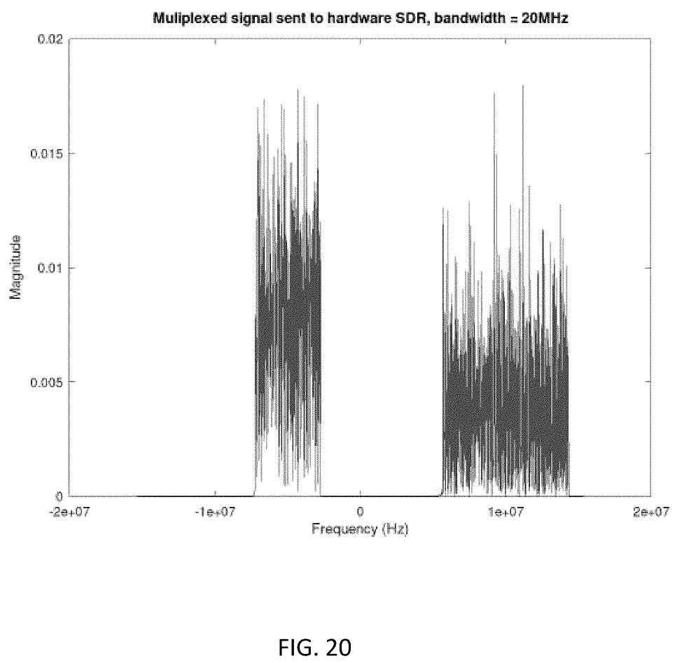

Because the resource grid is 20 MHz total bandwidth, FIG. 20 illustrates a plot of the resultant signal after shifting the UE-1 signal 5 MHz to the left of the resource grid and the UE-2 signal 10 MHz to the right of the resource grid by multiplying the reference signal at the baseband. This resultant signal is generated by combining the two signals and the frequency ‘fc’ after applying the up conversion process.

This resultant signal is transmitted into the communication medium which is received at the access point (e.g., gNB for 5G). As per the resources scheduled by the access point in frequency and time, the frequency location of UE-1 and UE-2 transmission signals are shared over a same time interval. The receiving access point is then operable to extract the individual UE signals by using frequency division multiple access (FDMA) procedure accordingly.

FDMA Down-Link Transmission Example

At the down-link, the signal extraction is the reverse process of transmission. The same resultant signal from the previous example (shown in FIG. 20) is used in this example. The signals corresponding to UE-1 and UE-2 are extracted from the multiplexed baseband signal and compared with the original signal. The access point (e.g., gNB), UE-1, and UE-2 configurations are the same as the up-link transmission example.

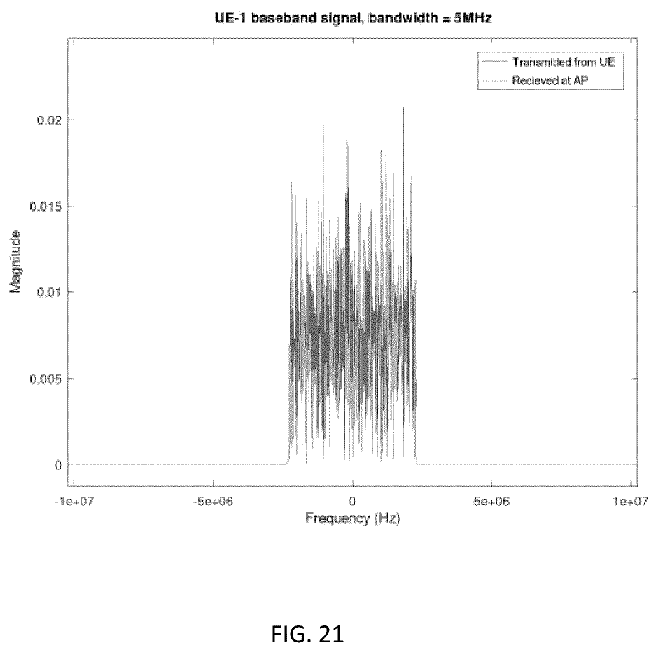

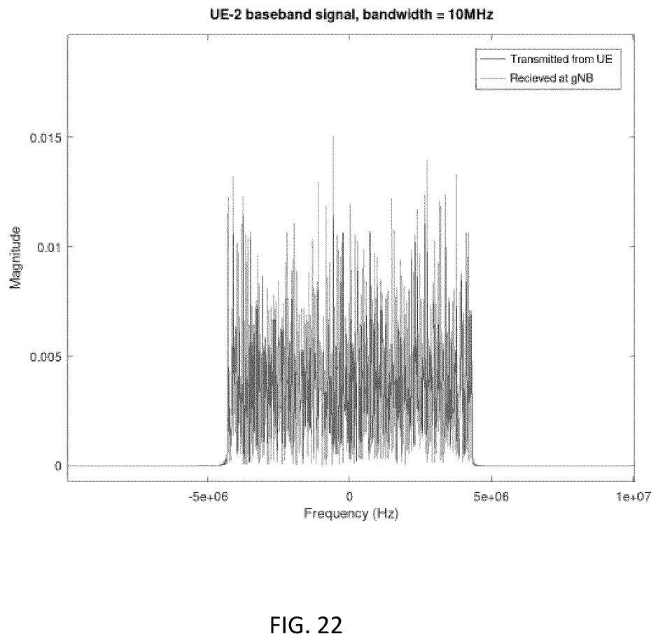

Frequency shifting is performed to bring the baseband signal of the required FDM channel to the zeroth frequency. FIG. 21 illustrates a comparison plot between the original generated signal at the transmitter for UE-1 and the extracted signal at the receiver for UE-1. FIG. 22 illustrates a comparison plot between the original generated signal at the transmitter for UE-2 and the extracted signal at the receiver for UE-2. As shown in FIGS. 21-22, there is substantial overlap of the original generated signal and the extracted signal at the receiver for both UE-1 and UE-2.

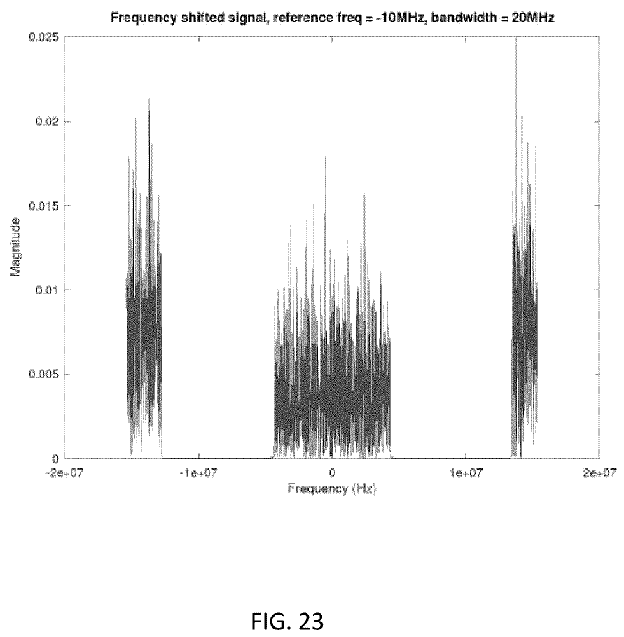

FIG. 23 illustrates the frequency shifted signal. The total bandwidth is shifted by the same amount. Only after filtering is the required signal extracted.

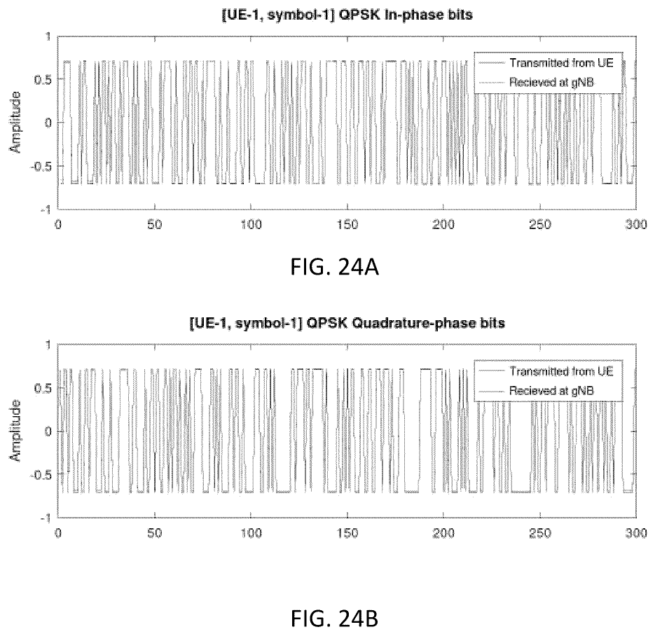

Filtering removes the unwanted signals from the baseband signal. High sampling rate signals are required to be down sampled and distributed to the corresponding UEs. Noting that the sequence length of UE-1 is 552 for one symbol and the sequence length of UE-2 is 1104 for two symbols, FIGS. 24A-26B illustrate the extracted QPSK bits compared with the original signal generated at the transmitter.

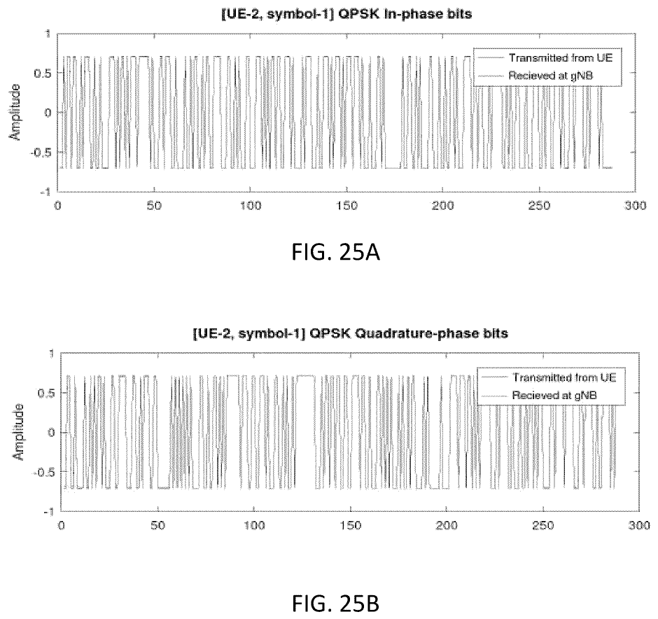

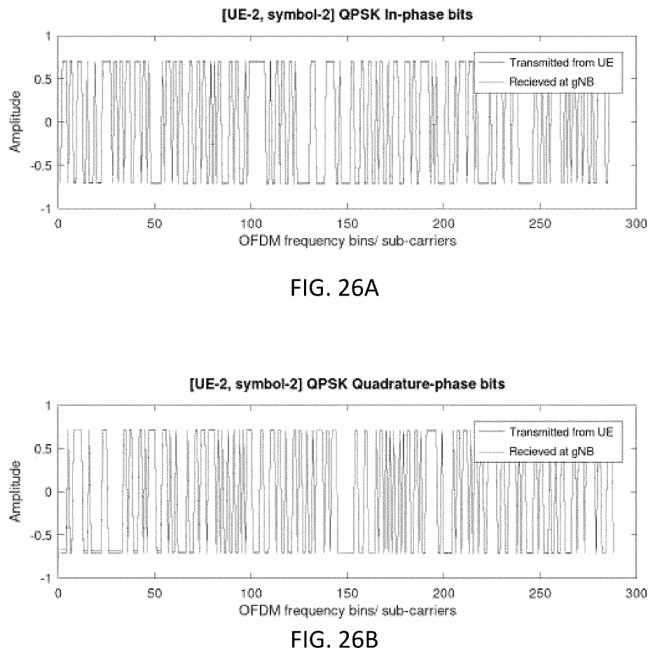

FIG. 24A illustrates the QPSK in-phase bits for UE-1, Symbol 1. FIG. 24B illustrates the QPSK quadrature bits for UE-1, Symbol 1. FIG. 25A illustrates the QPSK in-phase bits for UE-2, Symbol 1. FIG. 25B illustrates the QPSK quadrature bits for UE-2, Symbol 1. FIG. 26A illustrates the QPSK in-phase bits for UE-2, Symbol 2. FIG. 26B illustrates the QPSK quadrature bits for UE-2, Symbol 2. As shown in FIGS. 23A-26B, there is substantial overlap of the original generated signal and the extracted signal at the receiver for both UE-1 and UE-2.

Modes

In one embodiment, the system includes a transparent mode. Transparent mode does not require modification of the protocol implementation of the wireless stack. In transparent mode, communication between the virtual radio interface and the wireless stacks uses time domain samples. In the transparent mode, all stack layer functionality of individual UE stacks need not be modified, while the signals to be transmitted are combined as described herein.

Additionally or alternatively, the system includes a performance mode. In one embodiment, performance mode requires some modifications at the low physical layer of the wireless stack. In performance mode, communication between the virtual radio interface and the wireless stack uses frequency domain samples. In one embodiment, some functionality of the low physical layer (low-PHY) moves to the superposition unit and/or the broadcast unit. Examples of functionality that moves to the superposition unit and/or the broadcast unit includes, but is not limited to, fast Fourier transform (FFT), inverse fast Fourier transform (IFFT), addition, and/or removal of cyclic prefix. Advantageously, this avoids repetition of these tasks in each UE.

For example, and not limitation, if the UE protocol involves OFDM based transmission, the total bandwidth is divided into subcarriers, and the total bandwidth is frequency divided using FDMA for sharing by multiple UEs, then it would be advantageous (e.g., in terms of execution speed and system power) to shift the OFDM symbol operations like IFFT in DL and FFT in UL towards the vSDR driver instead of the UE. The IFFT/FFT makes it possible to combine and/or extract multiple UE signals over the communication medium in the frequency domain itself. In one embodiment, this eliminates or simplifies the use of time domain combining of signals described above with respect to transparent mode. Additionally, when in performance mode, the UE stack alone is modified while the implementation of the access point need not be changed and/or modified.

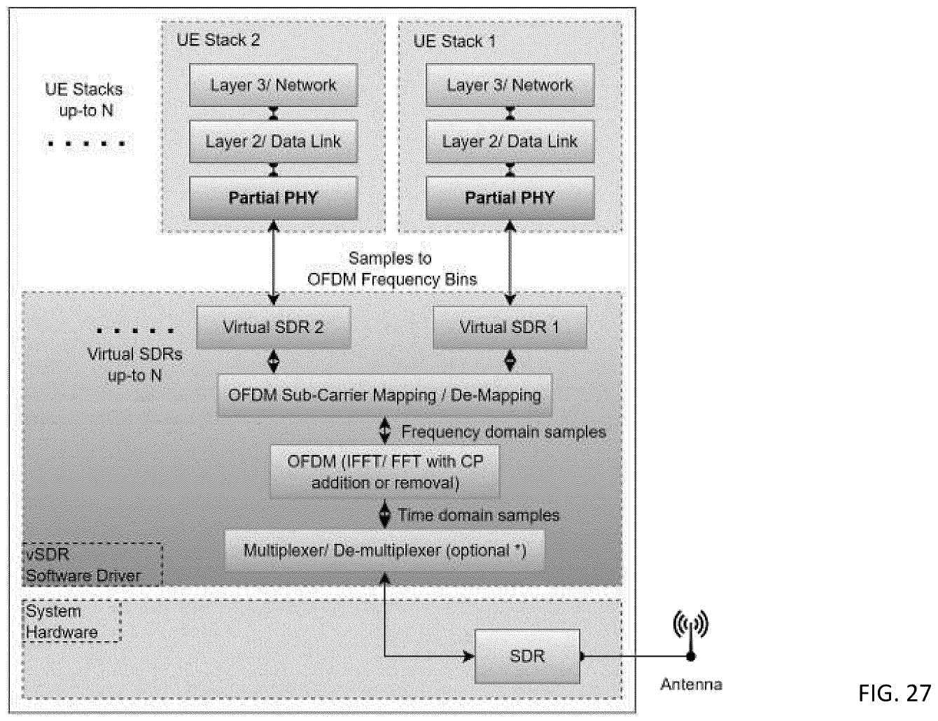

In one embodiment, as seen in FIG. 27, the UE PHY layer submits frequency bin samples to the vSDR. When the subcarriers assigned to multiple UEs do not overlap during the same time interval, then the sub-carriers for all the UEs are mapped onto a signal OFDM (IFFT) operation and this signal is converted into a transmission bandwidth that is sent to the hardware SDR. In one embodiment, the length of IFFT or FFT operation of the OFDM symbol depends on the sampling rate of the baseband signal and the subcarrier spacing of the frequency bins. In one embodiment, the sampling rate is defined for the total bandwidth of the transmission signal (or bandwidth configured at hardware SDR). In one embodiment, the subcarrier spacing is defined by the channel conditions of the wireless channel. In one embodiment, these two parameters (sampling rate and subcarrier spacing) are pre-defined at the protocol level for wireless technologies, including, but not limited to, WI-FI and LTE. However, in 5G, the protocol gives many options of sub-carrier spacings referred to as numerology. Unlike LTE, 5G access points (e.g., gNB) preferably support UEs with mixed numerologies (e.g., 100 UEs operating on 15 KHz subcarrier spacing and 150 UEs operating on 30 KHz subcarrier spacing) simultaneously.

Advantageously, when all the UEs are operating on the same numerology (subcarrier spacing) (e.g., as in WI-FI and LTE), a single IFFT and/or a single FFT operation is sufficient to combine the baseband signal for transmission. Further, multiplexing and/or de-multiplexing units are not required for transmission.

However, in the case where UEs are operating on at least two numerologies, each numerology group requires a separate IFFT and/or a separate FFT operation to convert these signals into baseband time domain signals. In one embodiment, each of the numerology baseband signals are combined in the time domain using the transparent mode technique as described above. Although this requires additional steps for combining signals, it is more computationally efficient compared to just performing transparent mode.

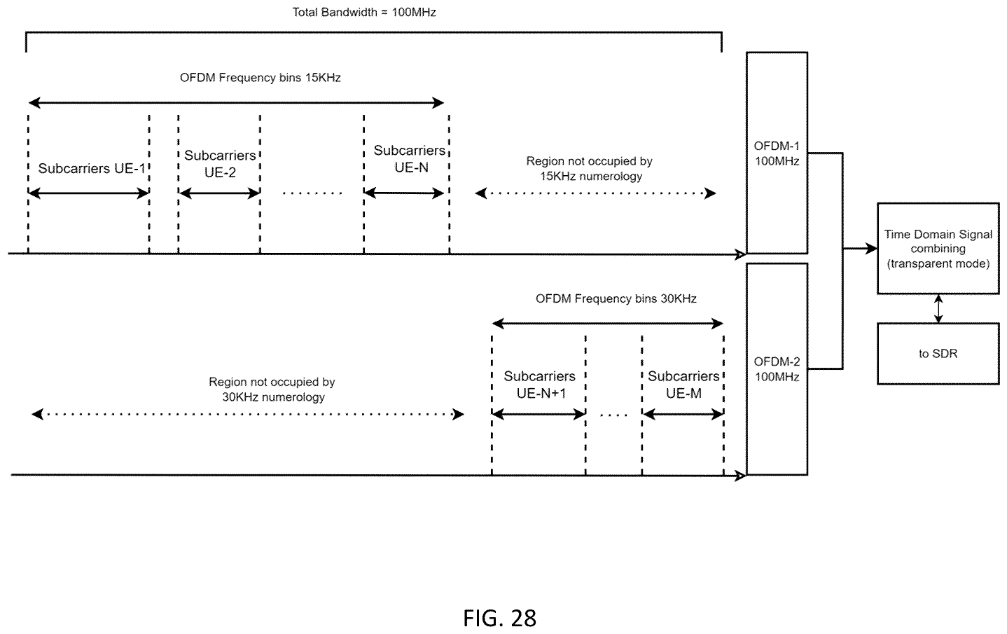

In one example, a UE simulator is configured for 100 UEs operating on 15 KHz subcarrier spacing and 150 UEs operating on 30 KHz subcarrier spacing. In order to multiplex the baseband signal of all the UEs over a total bandwidth of 100 MHz, either transparent mode or performance mode are operable to be used. Using transparent mode requires up to 250 array additions (i.e., 100+150) based on the scheduling requirements for all the UEs in time and frequency. If performance mode is applied, the total computation requirement results in 2 IFFT/FFT units and only 2 array additions and, therefore, boosts the performance of the system. FIG. 28 illustrates an example of performance mode.

In one embodiment, the performance mode for a UE simulator involves IFFT/FFT computed in the vSDR for the overall bandwidth required by all the UEs. The length of the FFT operations depends on the sampling rate and subcarrier spacing. In one non-limiting example, subcarrier spacing of 30 kHz and sampling rate 122.88 MHz provides an FFT length according to the equation below:

$$FFT ( {N}_{f} ) = \frac{Sampling rate ( {f}_{s} )}{Subcarrier spacing ( Δ f )} = \frac{12 2.88 MHz}{30 kHz} = 4096$$

In this non-limiting example, an FFT size of 4096 or less is computationally efficient in terms of power and speed. The present invention is compatible with a plurality of FFT sizes.

Use Cases

In one embodiment, the system is used to create a multi-UE simulator with a single UE stack. Advantageously, the present invention provides a plurality of UEs that do not share the same physical layer. Further, the present invention is compatible with commercial and open-source UE stacks. In one embodiment, the multi-UE simulator is operable to provide validation of base stations.

In one embodiment, the system is used to transform a UE into a device operable to handle multiple connections using a single radio interface. Generally, a multi-subscriber identity module (multi-SIM) allows switching between a plurality (e.g., up to 12) of stored numbers in a phone. However, only one of the plurality of stored numbers is operable to be active at a time. Advantageously, the present invention is operable to provide multi-SIM functionality with the plurality of stored numbers active at a time.

Generally, in the prior art, multi-SIM operation on a UE device (e.g., either available from the same operator or multiple operators) that is installed and operated on a single UE stack requires multiple radio hardware (e.g., at least one SDR) for each SIM because the base stations over which the UE is serviced for each SIM may be different and/or separated in frequency bands. In this case, each frequency band requires a separate SDR device to achieve simultaneous communication or data transfer requirements. In contrast, the present invention provides operation of multi-SIM configurations of UE over a single radio hardware, which is an advantage over the prior art.

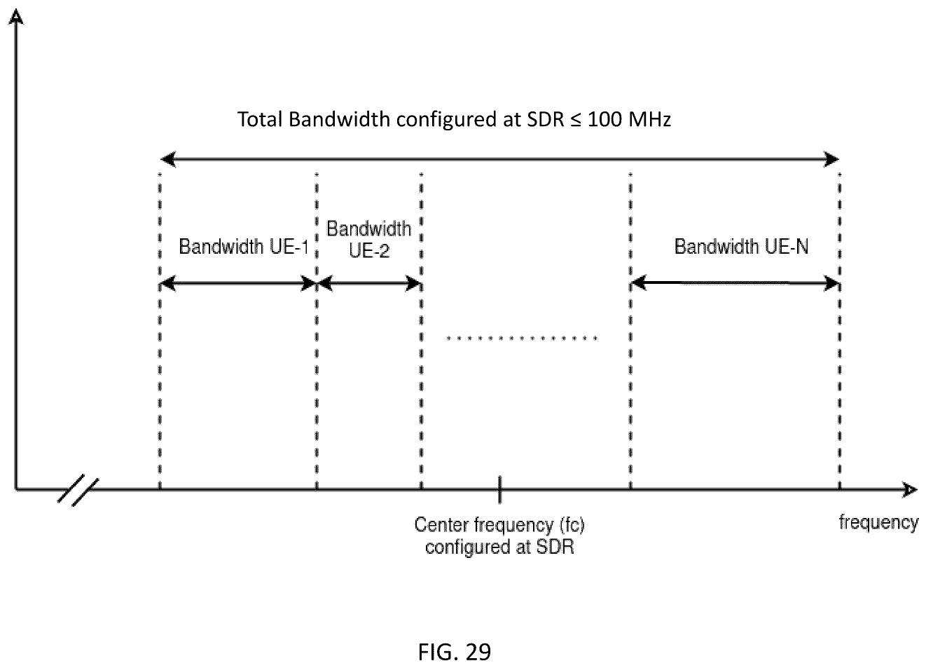

In one embodiment, all UE instances within the host system share the frequency and time resources allocated by the access points. The frequency resources shared by these UE instances come with bandwidth limitations from the SDR device being used. For example, if ‘N’ UEs use a total bandwidth less than or equal to 100 MHz, then an SDR device (physical radio hardware) with a bandwidth configuration of 100 MHz is operable to be used in an application as shown in FIG. 29.

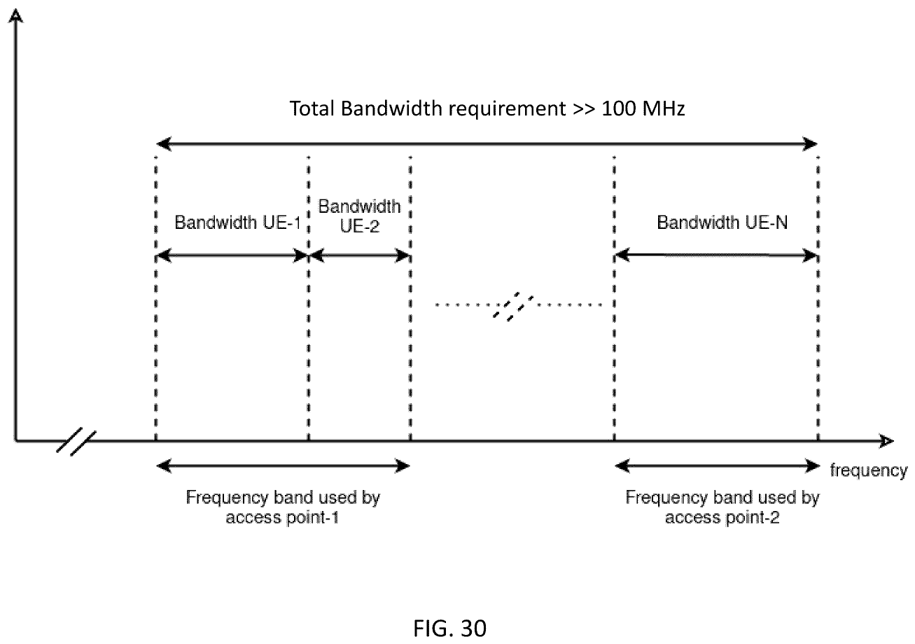

However, if the bandwidth requirement is greater than 100 MHz (e.g., 500 MHz, 1 GHz), the SDR device with the bandwidth configuration of 100 MHz is not operable to be used. For example, and not limitation, in one embodiment, power consumption and/or hardware size are used to determine whether multi-SIM is practical when compared to using separate radio hardware with less bandwidth. An example is shown in FIG. 30 where a first operator has a first frequency band using a first access point and a second operator has a second frequency band using a second access point. If the practical bandwidth requirement of a hardware device is 100 MHz and the total bandwidth requirement is much larger than 100 MHz (e.g., 500 MHz, 1 GHz), it is not practical to use the hardware device. One of ordinary skill in the art will recognize that the practical bandwidth requirement of the hardware device depends on the requirements of the particular implementation, and compatibility of the hardware device depends on both the practical bandwidth requirement and the total bandwidth requirement. The practical bandwidth requirement of the hardware device is not limited to 100 MHz, and the present invention is compatible with a plurality of practical bandwidth requirements.

Another example use case, presented for example and not limitation, includes carrier aggregation of UE to achieve high data rates. Carrier aggregation means a single UE device communicates with two or more base stations (e.g., gNB in 5G) that are separated by frequency bands to achieve a higher throughput in data transfer. The basic requirements of such systems include accommodating multiple radio devices (or at least one SDR) that are configured to each of the frequency bands or to modify the UE PHY layer to achieve sharing of the SDR as described in FIG. 9. Advantageously, the present invention is operable to achieve this via virtualization of radio hardware without additional hardware units or requiring UE PHY modifications.

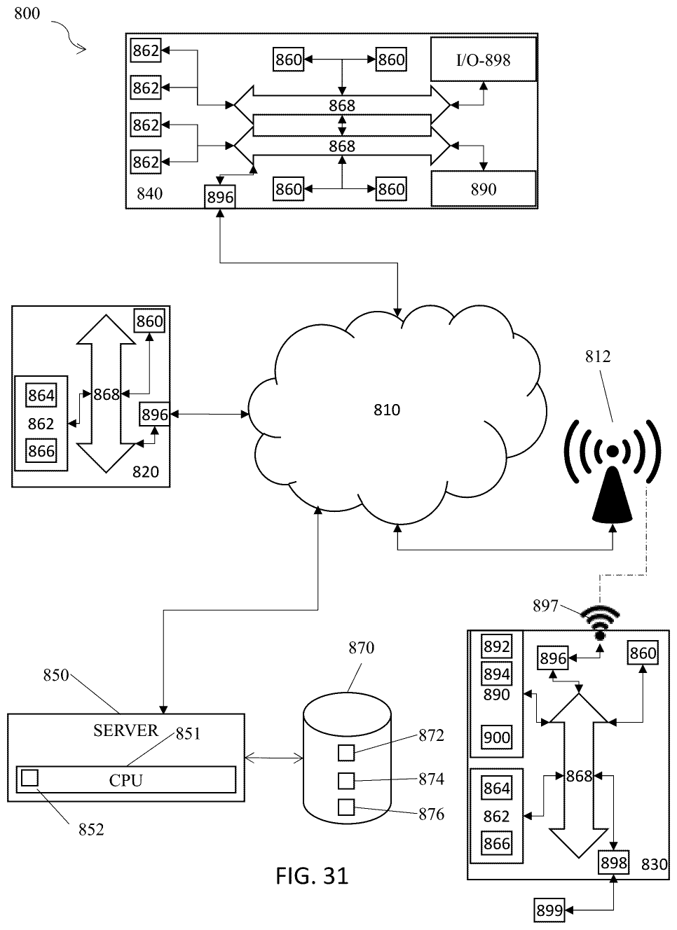

FIG. 31 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 31, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 31, is operable to include other components that are not explicitly shown in FIG. 31, or is operable to utilize an architecture completely different than that shown in FIG. 31. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for a virtualized radio interface, comprising:
at least one virtualized software defined radio interface driver (vSDR driver);
at least one software defined radio interface driver (SDR driver);
a plurality of user equipment (UEs);
a plurality of UE stacks;
at least one virtual port;
wherein the at least one vSDR driver is compatible with a plurality of wireless protocol technologies;
wherein the at least one vSDR driver combines a signal in an up-link (UL) direction for each of the plurality of UEs and streams a conjugated signal to the at least one SDR driver;
wherein each instance of the plurality of UE stacks connects to the at least one virtual port to send and/or receive data streams; and
and wherein the plurality of UEs are operable to stream digital signals constructed in a baseband.

2. The system of claim 1, wherein the virtualized radio interface is compatible with a plurality of commercial or open source UE stacks.

3. The system of claim 1, wherein the SDR of the vSDR is operable to be configured in real time or near-real time.

4. The system of claim 1, wherein the plurality of wireless protocol technologies utilizes multiple access techniques.

5. The system of claim 1, wherein the multiple access techniques include Frequency Division Multiple Access (FDMA), Orthogonal Frequency Division Multiple Access (OFDMA), and/or Time Division Multiple Access (TDMA).

6. The system of claim 1, wherein each of the plurality of UEs operate on the same numerology such that a single inverse fast Fourier transform (IFFT) and/or a single fast Fourier transform (FFT) operation is sufficient to combine a baseband signal for transmission.

7. The system of claim 1, wherein no changes to the implementation of at least one access point are required to run the plurality of UE stacks on a common host.

8. A system for a virtualized radio interface, comprising:
at least one virtualized software defined radio interface driver (vSDR driver);
at least one software defined radio interface driver (SDR driver);
a plurality of user equipment (UEs);
at least one virtual port;
wherein the at least one vSDR driver is compatible with a plurality of wireless protocol technologies;
wherein the at least one vSDR driver combines a signal in an up-link (UL) direction for each of the plurality of UEs and streams a conjugated signal to the at least one SDR driver;
wherein each instance of the plurality of UE stacks connect to the at least one virtual port to send and/or receive data streams;
wherein the plurality of UEs is operable to stream digital signal constructed in a baseband; and
wherein the at least one SDR is responsible for up-conversion to radio frequency (RF).

9. The system of claim 8, wherein the virtualized radio interface is compatible with a plurality of commercial and open source UE stacks.

10. The system of claim 8, wherein the plurality of wireless protocol technologies includes Fourth Generation Long Term Evolution (4G-LTE) and/or Fifth Generation new Radio (5G-NR).

11. The system of claim 8, wherein the virtualized radio interface is operable to evaluate a single UE attached to multiple operators, where each operator requires a different radio channel.

12. The system of claim 8, wherein the plurality of UEs operate on different numerologies such that each numerology group requires a separate inverse fast Fourier transform (IFFT) and/or a separate fast Fourier transform (FFT) operation to convert signals into baseband time domain signals.

13. The system of claim 8, wherein the plurality of wireless protocol technologies utilizes multiple access techniques.

14. The system of claim 8, wherein no changes to the implementation of at least one access point are required to run the plurality of UE stacks on a common host.

15. A method of a virtualized radio interface, comprising:
at least one virtualized software defined radio interface driver (vSDR driver);
at least one software defined radio interface driver (SDR driver);
a plurality of user equipments (UEs);
at least one virtual port;
providing a vSDR driver compatible with a plurality of wireless protocol technologies;
streaming digital signals constructed in a baseband via the plurality of UEs;
sharing physical resource of the plurality of UEs on a single SDR driver;
running the plurality of UE stacks on a common host via UE platforms;
configuring a radio channel according to physical requirements of the plurality of UEs while transmitting data in an up-link (UL) or receiving data through a down-link (DL); and
providing parallel use of the radio by different instances of the plurality of UE stacks.

16. The method of claim 15, further comprising streaming digital signals constructed in a baseband via the plurality of UEs.

17. The method of claim 15, further comprising converting digital signals to radio frequency (RF) signals.

18. The method of claim 15, further comprising operating multi-SIM configurations of UE over a single radio hardware.

19. The method of claim 15, further comprising evaluating at least one access point in terms of a capacity of the at least one access point.

20. The method of claim 15, further comprising the plurality of wireless protocol technologies utilizing multiple access techniques.
